(19) United States
(12) Patent Application Publication
(10) Pub. No.: US 2026/0331924 A1
(43) Pub. Date: Oct. 22, 2026

(54) SYSTEMS AND METHODS FOR BATTERY-TO-BATTERY CHARGING

(71) Applicant: Caterpillar Inc., Peoria, IL (US)

(72) Inventors: Umesh B S, Tumakuru (IN); Karthikeyan Kottaisamy, Ramanathapuram (IN); Malay Bhunia, Paschim Medinipur (IN); Souvik Das, Bangalore (IN)

(73) Assignee: Caterpillar Inc., Peoria, IL (US)

(21) Appl. No.: 19/184,879

(22) Filed: Apr. 21, 2025

(51) Int. Cl. H02J 7/34; H02J 7/00

(52) U.S. Cl. CPC H02J 7/342; H02J 7/345; H02J 7/94; H02J 7/96; H02J 2207/20

(57) ABSTRACT

At least one aspect of the present disclosure is directed to systems and methods for battery-to-battery charging. The system can include first direct current (DC)-to-direct current (DC) converter configured to connect to a first battery. The system can further include a second DC-to-DC converter configured to connect to a second battery. The system can further include a DC link connecting the first DC-to-DC converter to the second DC-to-DC converter. The system can further include a controller. The controller can be configured to determine an operation mode based on a first battery voltage of the first battery, a second battery voltage of the second battery, and a power flow direction. The controller can be further configured to control a first set of one or more switches corresponding to the first DC-to-DC converter and a second set of one or more switches corresponding to the second DC-to-DC converter based on the operation mode.

### TECHNICAL FIELD

The present implementations relate generally to the field of battery charging, and more particularly systems and methods for battery-to-battery charging.

### BACKGROUND

Non-isolated direct current-to-direct current (DC-to-DC) converters can be configured to share energy between batteries, such as high voltage (HV) traction battery packs of electric machines. These converters can require a minimum voltage difference between a first battery and a second battery (e.g., 50V) in order to charge a battery. In other words, a first battery ordinarily cannot charge a second battery via non-isolated DC-to-DC converters when the first battery voltage is the same as the second battery voltage. Further, the operational mode of non-isolated DC-to-DC converters (e.g., buck mode, boost mode, etc.) can depend on the first battery voltage and the receiver battery voltage. For example, a non-isolated bidirectional DC-to-DC converter with a half bridge topology can only boost a voltage in one direction but will not be able to buck the voltage in the same direction. Similarly, the non-isolated bidirectional DC-to-DC converter with the half bridge topology can buck a voltage in an opposite direction but will not be able to boost the voltage in the opposite direction.

For example, European Patent No. 3,301,799 describes a non-isolated bidirectional DC-DC converter having improved stability. One aspect of European Patent No. 3,301,799 provides a non-isolated DC-to-DC converter connected to a high voltage power source and a low voltage power source. If the non-isolated bidirectional DC-DC converter is operated, the high-voltage power source is electrically connected to the DC-DC converter unit to apply power to a load device using a high voltage or charges the low-voltage power source. If the non-isolated bidirectional DC-DC converter is operated, the low-voltage power source applies power to a load device using a low voltage or charges the high-voltage power source.

### SUMMARY

A first aspect provided herein relates to a system for battery-to-battery charging. The system can include a circuit. The circuit can include a first direct current (DC)-to-direct current (DC) converter configured to connect to a first battery. The circuit can further include a second DC-to-DC converter configured to connect to a second battery. The circuit can further include a DC link connecting the first DC-to-DC converter to the second DC-to-DC converter. The system can further include a controller connected to the circuit. The controller can be configured to determine an operation mode, from a plurality of operation modes, based on a first battery voltage corresponding to the first battery, a second battery voltage corresponding to the second battery, and a power flow direction. The controller can be further configured to control a first set of one or more switches corresponding to the first DC-to-DC converter and a second set of one or more switches corresponding to the second DC-to-DC converter based on the operation mode, to supply power from one of the first battery or the second battery, to a different one of the first battery or the second battery, according to the power flow direction.

A second aspect provided herein relates to a method for battery-to-battery charging. The method can include receiving, via a controller, a request to charge at least one of a first battery and a second battery. The method can further include determining, by the controller, an operation mode, from a plurality of operation modes, corresponding to a first direct current (DC)-to-DC converter (DC) connected to the first battery and a DC link, and a second DC-to-DC converter connected to the second battery and the DC link, based on a first battery voltage corresponding to the first battery, a second battery voltage corresponding to the second battery, and a power flow direction indicated by the request. The method can further include transmitting, by the controller, one or more signals to a first set of switches corresponding to the first DC-to-DC converter and a second set of switches corresponding to the second DC-to-DC converter based on the operation mode to charge the first battery or the second battery.

A third aspect provided herein relates to a power transfer unit. The power transfer unit can include a housing. The power transfer unit can further include a circuit contained within the housing. The circuit can include a first direct current (DC)-to-direct current (DC) converter configured to connect to a first battery. The circuit can further include a second DC-to-DC converter configured to connect to a second battery. The circuit can further include a DC link connecting the first DC-to-DC converter to the second DC-to-DC converter. The system can further include a controller connected to the circuit and contained within the housing. The controller can be configured to determine an operation mode, from a plurality of operation modes, based on a first battery voltage corresponding to the first battery, a second battery voltage corresponding to the second battery, and a power flow direction. The controller can be further configured to control a first set of one or more switches corresponding to the first DC-to-DC converter and a second set of one or more switches corresponding to the second DC-to-DC converter based on the operation mode, to supply power from one of the first battery or the second battery, to a different one of the first battery or the second battery, according to the power flow direction.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a charging system connected to a first battery and a second battery, in accordance with present implementations.

FIG. 2 is a detailed view of the charging system of FIG. 1, in accordance with present implementations.

FIG. 3 is a diagram of a housed charging system connected to a first battery and a second battery, in accordance with present implementations.

FIG. 4 is a flowchart showing a method for battery-to-battery charging, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement battery-to-battery charging. Generally, high frequency isolated bidirectional DC-to-DC converters can facilitate bidirectional battery-to-battery charging when the batteries have the same or different voltages. The systems and methods described herein can facilitate bidirectional battery-to-battery charging between batteries when the batteries have the same or different voltages using a non-isolated bidirectional DC-to-DC converter topology. According to the systems and methods described herein, a controller can control a first DC-to-DC converter and a second DC-to-DC converter connected together via a DC link, according to one or more operation modes to charge a first battery connected to the first DC-to-DC converter or a second battery connected to the second DC-to-DC converter.

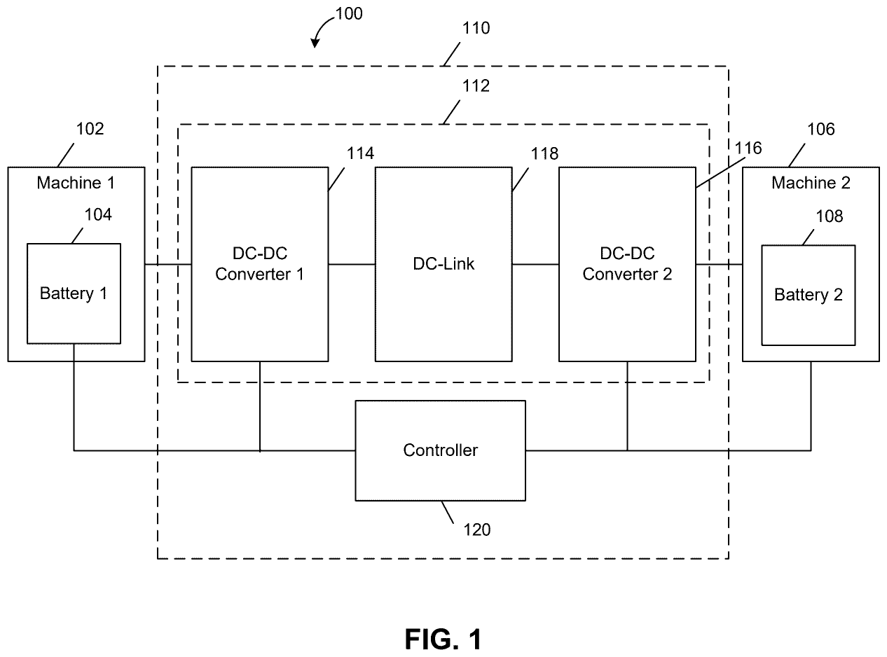

FIG. 1 is a block diagram of a system 100 for charging a first battery 104 of a first machine 102 and/or a second battery 108 of a second machine 106. The system 100 can include the first machine 102 including first battery 104, the second machine 106 including the second battery 108, and a charging system 110 including a circuit 112, first DC-to-DC converter 114, second DC-to-DC converter 116, DC link 118, and controller 120. First machine 102 and second machine 106 can be any machine that include one or more batteries. For example, first machine 102 and second machine 106 can be electric vehicles, heavy machinery (e.g., excavators, bulldozers, cranes, dump trucks, etc.), or any other machine configured for battery-to-battery charging. In some aspects, first machine 102 and second machine 106 are the same or different machines. Further, first battery 104 can be representative of one or more batteries in first machine 102 and second battery 108 can be representative of one or more batteries in second machine 106. For example, first battery 104 and second battery 108 can include a first battery pack and a second battery pack respectively, where the first battery and the second battery back include one or more batteries. In some aspects, the first battery pack and the second battery pack can include high voltage (HV) traction battery packs. Further, first battery 104 and second battery 108 can include lead acid batteries, lithium-ion batteries, nickel-based batteries, solid-state batteries, flow batteries, or any other battery that could be included in a machine. In various embodiments, and as described in greater detail below, the first battery 104 can charge second battery 108 via charging system 110, or second battery 108 can charge first battery 104 via charging system 110. The first battery 104 can correspond to a first battery voltage and the second battery 108 can correspond to a second battery voltage, where the first battery voltage and the second battery voltage can be the same or different.

The system 100 can include charging system 110 and circuit 112. Charging system 110 can include circuit 112 and controller 120. Circuit 112 can be implemented on a printed circuit board, a field programable gate array (FPGA), an application specific integrated circuit (ASIC), a combination thereof, or any other implementation. In some aspects, circuit 112 can include first DC-to-DC converter 114, second DC-to-DC converter 116, and DC link 118. For example, circuit 112 can correspond to a two-stage non-isolated bidirectional DC-to-DC converter. Circuit 112 also can include a plurality of DC-to-DC converters with a plurality of DC links. For example, circuit 112 can include a first DC-to-DC converter, a second DC-to-DC converter, and a third DC-to-DC converter, where a first DC link connects the first DC-to-DC converter and the second DC-to-DC converter and a second DC link connects the second DC-to-DC converter and the third DC-to-DC converter. Further, circuit 112 can include transistors (e.g., metal oxide semiconductor field effect transistors (MOSFET), bipolar junction transistor (BJT), insulated gate bipolar transistors (IGBT), etc.) diodes (e.g., freewheeling diodes, Schottky diodes, fast recovery diodes, etc.), capacitors (e.g., electrolytic capacitors, ceramic capacitors, tantalum capacitors, etc.), inductors, gate drive circuits voltage/current sensing circuits, overcurrent/overvoltage protection circuits, thermal protection circuits, heat dissipation components (e.g., heat sinks, thermal pads/paste, fans, etc.), commutation interfaces (e.g., I2C, SPI, UART, CAN, etc.), and any other circuity components included in a circuit that includes one or more DC-to-DC converters.

Circuit 112 can include first DC-to-DC converter 114 and second DC-to-DC converter 116. First DC-to-DC converter 114 can connect to first machine 102 and/or first battery 104 and second DC-to-DC converter 116 can connect to second machine 106 and/or second battery 108. First DC-to-DC converter 114 and second DC-to-DC converter 116 can include one or more non-isolated bi-directional DC-to-DC converters. For example, power can flow between the input and output of the DC-to-DC converter without any electrical isolation (e.g., galvanic isolation) between the input and the output. First DC-to-DC converter 114 and second DC-to-DC converter can include one or more non-isolated bi-directional converter topologies. For example, first DC-to-DC converter 114 and second DC-to-DC converter 116 can include bidirectional buck-boost converters (e.g., three-level bidirectional interleaved converters, three-level bidirectional neutral-point clamped converters, cascaded buck-boost converters, etc.), bidirectional Cuk converters, bidirectional SEPIC-Ćuk converter, switched-capacitor bidirectional converters, switched-capacitor, bidirectional Z-Source converters, and any other non-isolated bidirectional converter that is applicable in the context of battery-to-battery charging. Further, first DC-to-DC converter 114 and second DC-to-DC converter 116 can include the same or different topologies/configurations. For example, first DC-to-DC converter 114 and second DC-to-DC converter 116 can be buck-boost DC-to-DC converters. In some aspects, first DC-to-DC converter 114 and second DC-to-DC converter 116 can include one or more control loops to regulate a DC link voltage of DC link 118.

Circuit 112 can include DC link 118. DC link 118 can connect first DC-to-DC converter 114 to second DC-to-DC converter 116. For example, DC link 118 can bridge connect first DC-to-DC converter 114 to second DC-to-DC converter 116. DC link 118 can include one or more capacitors, where the one or more capacitors can be in series or parallel. The capacitors of DC link 118 can include electrolytic capacitors, film capacitors, or any other capacitor used in a DC link 118. Further, the capacitors can be included to smooth high frequency ripples generated by switching switches corresponding to first DC-to-DC converter 114 and second DC-to-DC converter 116. In some aspects, DC link 118 can serve as an energy buffer between first DC-to-DC converter 114 and second DC-to-DC converter 116. For example, one or more capacitors corresponding to DC link 118 can store energy to maintain a reference/intermediate voltage at DC link 118, where the energy stored at DC link 118 can provide energy to the first DC-to-DC converter 114 or second DC-to-DC converter 116 depending on the configuration. In some aspects, DC link 118 decouples first DC-to-DC converter 114 from second DC-to-DC converter 116. For example, DC link 118 separates first DC-to-DC converter 114 from second DC-to-DC converter 116 such that first DC-to-DC converter 114 from second DC-to-DC converter 116 can operate at different switching frequencies and/or duty cycles without interfering with each other.

Charging system 110 can include controller 120, where controller 120 can represent one or more controllers for controlling circuitry in the system 100. Controller 120 can be a programmable electronic control unit configured to interface with one or more components of the system 100. Controller 120 can include one or more ports to interface with the one or more components of system 100, such as gate drive signal ports, relay ports, digital output ports, CAN ports, GPIO ports, and any other port that can allow controller 120 to interface with the one or more components of the system 100. Controller 120 can include one or more processing circuits, such as microcontrollers, digital signal processors (DSPs), field-programmable gate array (FPGAs), and/or application-specific integrated circuit (ASICs), capable of interpreting one or more computer-readable instructions. Controller 120 can also include one or more memory units, including volatile memory (e.g., RAM), non-volatile memory (e.g., flash memory), electrically erasable programmable read-only memory (EEPROM), read-only memory (ROM), static random access memory (SRAM), hard disk drives (HDD), solid-state drives (SSD), and other types of memory used by a controller in the context of DC-to-DC battery charging. The one or more memory units of controller 120 can store instructions and the one or more processing circuits of controller 120 can load the instructions and execute the instructions.

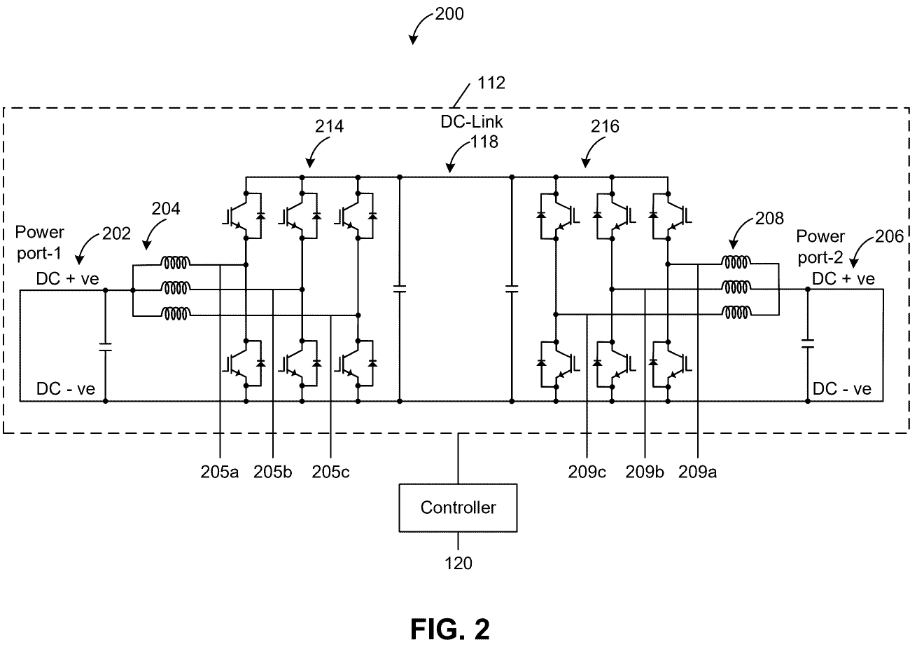

Controller 120 can measure voltages and/or currents of one or more electrical components in the system 100. Circuit 112 can include one or more measurement components that can connect to and/or interface with controller 120 to provide controller 120 voltage/current data corresponding to the one or more electrical components in the system 100. For example, circuit 112 can include voltage dividers, current sense resistors, hall sensors, shunt resistors, or any other voltage/current sensors. The one or more measurement components can measure a first battery voltage of first battery 104 and a second battery voltage of second battery 108, a DC link voltage of DC link 118, the current of first inductors 204 and second inductors 208 (as shown in FIG. 2), and the voltage/current of any other component included in the system 100.

Controller 120 can connect to circuit 112 and control circuit 112. For example, controller 120 can control one or more circuitry components corresponding to circuit 112, such as first DC-to-DC converter 114 and second DC-to-DC converter 116. In some aspects, first DC-to-DC converter 114 and second DC-to-DC converter 116 can include one or more corresponding switches (e.g., MOSFETs, IGBTs, etc.) and controller 120 can control (e.g., switch) the one or more corresponding switches. Controller 120 can generate one or more switching signals to control first DC-to-DC converter 114 and second DC-to-DC converter 116. Controller 120 can execute one or more control algorithms to generate the switching signals. For example, controller 120 can execute a pulse-width modulation control algorithm, a hysteresis control algorithm, a model predictive control algorithm, and any other control algorithm used to control switches in DC-to-DC converters. Controller 120 can base the one or more switching signals on voltage regulation, current control, and/or load demand. Circuit 112 can include one or more gate driver circuits to drive the one or more corresponding switches. The gate driver circuits can amplify the switching signals and/or provide high current switching signals.

In some aspects, controller 120 can control first DC-to-DC converter 114 and/or second DC-to-DC converter 116 to operate according to a voltage control mode and/or a current control mode. The voltage control mode can correspond to a single control loop system. Controller 120 can measure an output voltage (e.g., a DC link voltage of DC link 118 and/or a battery voltage of first battery 104 and second battery 108) and compare it to a reference voltage. Controller 120 can include a compensator (e.g., a PI and/or PID controller) to process the differences between the output voltage and the reference voltage and controller 120 can generate one or more switching signals (e.g., PWM signals), where controller 120 can adjust the duty cycle of the one or more switching signals to maintain the desired output voltage. Further, the current mode can correspond to a dual control loop system. In a first control loop, controller 120 can measure an output voltage (e.g., a DC link voltage of DC link 118 and/or a battery voltage of first battery 104 and second battery 108) and a compensator of controller 120 can compare the output voltage to a reference voltage. The compensator can set a reference current for inductors (e.g., first inductors 204 and/or second inductors 208) based on the voltage difference between the output voltage and the reference voltage. In a second control loop, controller 120 can determine an inductor current and can compare (e.g., via a comparator) the inductor current against the reference current. Controller 120 can transmit one or more switching signals to the corresponding switches to deactivate the corresponding switches once the inductor current reaches the reference current. In some aspects, controller 120 can cause a circumvention of at least one of the DC-to-DC converters (e.g., first DC-to-DC converter 114 and second DC-to-DC converter 116). In one example, controller 120 can transmit one or more signals to a DC-to-DC converter (e.g., first DC-to-DC converter 114 or second DC-to-DC converter 116) to disable the DC-to-DC converter. In another example, controller can transmit one or more signals to at least one relay, contactor, or switch connected to DC link 118 and at least one of the DC-to-DC converters (e.g., first DC-to-DC converter 114 and second DC-to-DC converter 116) to close the at least one relay, contactor or switch and create a bypass path circumventing the at least one DC-to-DC converter.

In some aspects, controller 120 can determine a first battery voltage of first battery 104 and a second battery voltage of second battery 108 and/or receive/determine a power flow direction. Controller 120 can determine the first battery voltage of first battery 104 and the second battery voltage of second battery 108 via the one or more measurement components connected to controller 120. The first battery voltage can be greater than, less than, or equal or the second battery voltage. Further, the power flow direction can be the direction of power flow. Power can flow from first battery 104 to second battery 108 or from second battery 108 to first battery 104. In some aspects, the power flow direction can be based on the state of charge of the batteries. For example, controller 120 can determine the state of charge of first battery 104 and second battery 108 and set the power flow direction based on whether first battery 104 or second battery 108 has a lower state of charge. In some aspects, the power flow direction can be based on user selection. For example, controller 120 can include a user interface configured to receive user inputs, where the user inputs can correspond to the power flow direction. The power flow direction can determine/define a source battery and a receiver battery, where first battery 104 and second battery 108 can be a source battery or a receiver battery. For example, the power flow direction can determine/define if first battery 104 is charging second battery 108 or if second battery 108 is charging first battery 104. Further, the power flow direction can determine/define a donor battery pack or a receiver battery pack, where first battery 104 and second battery 108 can be a donor battery back or a receiver battery pack. In some aspects, controller 120 can adjust the power flow direction by adjusting a reference current sign. For example, the current reference can adjust a +ve reference current corresponding to current flowing from a source to a load (e.g., a forward direction) to a −ve reference current corresponding to current flowing from a load to a source (e.g., a reverse direction).

Controller 120 can determine an operation mode based on the first battery voltage of first battery 104, the second battery voltage of second battery 108, and the power flow direction. The operation mode can include a boost mode or a buck mode, where the buck mode or boost mode can depend on power flow direction. Controller 120 can operate in a buck mode if the charging battery has a greater voltage than the receiver battery. For example, controller 120 may configure (e.g., switch) first DC-to-DC converter 114 and/or second DC-to-DC converter 116 to step down (e.g., decrease) the input voltage corresponding to the charging battery. Controller 120 can also operate in a boost mode if the charging battery has a greater voltage than the receiver battery. For example, controller 120 may configure (e.g., switch) the first DC-to-DC converter 114 and/or second DC-to-DC converter 116 to step up (e.g., increase) the input voltage corresponding to the charging battery. In some aspects, controller 120 can facilitate charging between first battery 104 and second battery 108 when the first battery voltage is equal to the second voltage. For example, controller 120 can facilitate charging between first battery 104 and second battery 108 in implementations where there is no voltage differential between first battery 104 and second battery 108. For example, controller 120 can operate in a boost mode when the first battery voltage is equal to the second battery voltage.

Controller 120 can operate in a boost mode or a buck mode by controlling one or more switches corresponding to first DC-to-DC converter 114 and second DC-to-DC converter 116. First DC-to-DC converter 114 and second DC-to-DC converter 116 can buck and/or boost input voltages based on the operation mode. In one example where the power flow direction flows from first battery 104 to second battery 108 and the first battery voltage is less than the second battery voltage, controller 120 can operate in the boost mode and configure first DC-to-DC converter 114 and second DC-to-DC converter to generate the desired output voltage (e.g., the second battery voltage) according to at least three different configurations. First, controller 120 can configure first DC-to-DC converter 114 to buck the input voltage (e.g., the first battery voltage) and configure second DC-to-DC converter 116 to boost the intermediate voltage of DC link 118. Second, controller 120 can configure first DC-to-DC converter 114 to buck the input voltage (e.g., the first battery voltage) and configure second DC-to-DC converter 116 to boost the intermediate voltage of DC link 118. Third, controller 120 can configure first DC-to-DC converter 114 to boost the input voltage (e.g., the first battery voltage) and configure second DC-to-DC converter 116 to buck the intermediate voltage of DC link 118. Similarly, it should be appreciated that the buck mode can correspond to at least three different configurations of first DC-to-DC converter 114 and second DC-to-DC converter 116. In another example where the power flow direction flows from first battery 104 to second battery 108 and the first battery voltage is equal to or about equal to the second battery voltage, controller 120 can operate in the boost mode and configure first DC-to-DC converter 114 and second DC-to-DC converter to generate the desired output voltage (e.g., the second battery voltage). Controller 120 can configure first DC-to-DC converter 114 to boost the input voltage (e.g., the first battery voltage) and configure second DC-to-DC converter 116 to operate in the current control mode.

Referring now to FIG. 2, a detailed view of the charging system of FIG. 1 is shown. Charging system 200 can include first power port 202, first inductors 204, first power lines 205a-205c (hereinafter referred to as “first power lines 205”), second power port 206, second inductors 208, second power lines 209a-209c (hereinafter referred to as “second power lines”), first switch set 214a-214c (hereinafter referred to as “first switch set 214”), second switch set 216a-216c (hereinafter referred to as “second switch set 216”), DC link 118, and controller 120.

Charging system 200 can include first power port 202 and second power port 206. First power port 202 can correspond to first battery 104 and second power port 206 can correspond to second battery 108. For example, first power port 202 can connect to first battery 104 to share the same voltage as first battery 104 and second power port 206 can connect to second battery 108 to share the same voltage as second battery 108. First power port 202 and second power port 206 can correspond to input and/or output ports depending on the power flow direction. For example, first power port 202 can be an input voltage if first battery 104 is the charging battery and second power port 206 can be the output voltage if second battery 108 is the receiver battery. In some aspects, first power port 202 and second power port 206 can include one or more corresponding capacitors. The one or more corresponding capacitors can minimize voltage ripples across first power port 202 and second power port 206 produced during switching events.

Charging system 200 can include first inductors 204 and second inductors 208. First inductors 204 and second inductors 208 can each include three inductors, where each inductor corresponds to a different phase (e.g., 120 degrees out of phase). First inductors 204 can connect to first power port 202 and second inductors 208 can connect to second power port 206. First battery 104 can produce a first current across first power port 202 when first battery 104 connects to first power port 202 and first battery 104 is the charging battery or the receiving battery. Similarly, second battery 108 can produce a second current across second power port 206 when second battery 108 connects to second power port 206 and second battery 108 is the charging battery or the receiving battery. The first current can be equally split between first inductors 204 and the second current can be equally split between the second inductors 208. The current across each of first inductors 204 can flow across each of first power lines 205 to each corresponding switch set of first switch set 214 and the current across each of second inductors 208 can flow across each of second power lines 209 to each corresponding switch set of second switch set 216. Each of first inductors 204 can store energy when each corresponding switch set of first switch set 214 are on and each of first inductors 204 can release the stored energy when each corresponding switch set of first switch set 214 are off. Similarly, each of second inductors 208 can store energy when each corresponding switch set of second switch set 216 are on and each of second inductors 208 can release the stored energy when each corresponding switch set of second switch set 216 are off. In some aspects, each corresponding switch set of first switch set 214 and second switch set 216 can include at least two switches.

It should be appreciated that the configuration of first DC-to-DC converter 114 and second DC-to-DC converter 116 can be modified to achieve the results of the example implementation shown in FIG. 2. For example, first DC-to-DC converter 114 and second DC-to-DC converter 116 can include one or more implementations that can facilitate bidirectional battery-to-battery charging when the first battery voltage and the second battery voltage are the same or different.

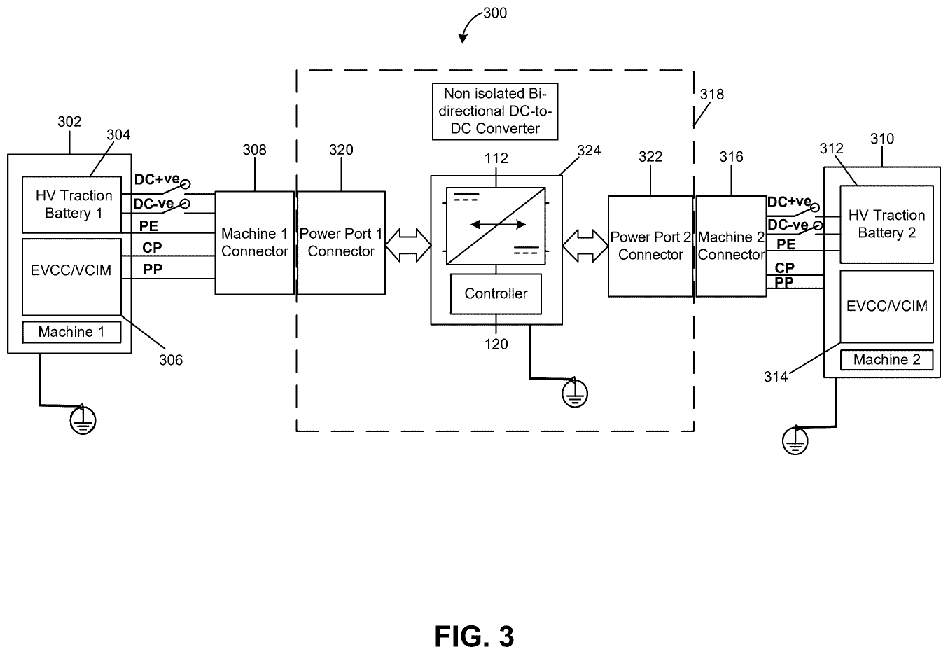

Referring now to FIG. 3, a diagram of a housed charging system 300 connected to a first battery and a second battery. Charging system 300 can include first machine 302, first battery 304, first interface controller 306, first machine connector 308, second machine 310, second battery 312, second interface controller 314, second machine connector 316, and power transfer unit 318. Power transfer unit 318 can include first power port connector 320, second power port connector 322, and housing 324. Housing 324 can include circuit 112 and controller 120. In some aspects, charging system 300 can corresponding to electric vehicle-to-electric vehicle (or electric machine-to-electric machine) charging.

Charging system 300 can include first machine 302 and second machine 310. First machine 302 and second machine 310 can include one or more types of electric machines. For example, first machine 302 and second machine 310 can include heavy machinery (e.g., cranes, excavators, loaders, forklifts, dump trucks etc.), electric vehicles, drones, robots, boats, e-bikes, scooters, medical devices, consumer electronics, and any other machine with a battery. First machine 302 can include first battery 304 and second machine 310 can include and second battery 312, where first battery 304 and second battery 312 can be representative of one or more batteries. In some aspects, first battery 304 and second battery 312 can include high voltage (HV) traction batteries. Further, first battery 304 and second battery 312 can include lithium-ion batteries, nickel-metal hydride batteries, solid-state batteries, and any other battery that could be included in an electric vehicle. Further, first machine 302 can include first interface controller 306 and second machine 310 can include second interface controller 314. First interface controller 306 and second interface controller 314 can include one or more electric vehicle communication controllers (EVCC). For example, first interface controller 306 and second interface controller 314 can include one or more controllers configured to establish a communication between the machine (e.g., first machine 302 and/or second machine 310) and charging system 110. In some aspects, the one or more EVCC can establish communication between the machine (e.g., first machine 302 and/or second machine 310) using one or more communication protocols (e.g., CAN BUS). Additionally, first machine 302 can include first machine connector 308 and second machine 310 can include second machine connector 316. First machine connector 308 and second machine connector 316 can include J1772 charging connectors, GB/T charging connectors, Mennekes charging connectors, combined charging system (CCS) charging connectors (type 1 and 2), CHAdeMO charging connectors, or any other electric vehicle charging connector.

First machine connector 308 and second machine connector 316 can include one or more corresponding pins for providing power (e.g., DC power or AC power), providing a neutral or ground line, completing a circuit, managing communication between the machine (e.g., first machine 302 and second machine 310) and circuit 112, and detecting a connection between the machine (e.g., first machine 302 and second machine 310) and circuit 112. The one or more corresponding pins can include one or more DC power pins, one or more AC power pins, a neutral pin, a protective earth/ground pin, a control pilot pin, a proximity pilot pin, and any other type of pin applicable in the context of electric vehicle-to-electric vehicle charging. In some aspects, first battery 304 and/or second battery 312 can connect to one or more corresponding DC pins and at least one corresponding protective earth pin, and first interface controller 306 and/or second interface controller 314 can connect to one or more corresponding control pilot pins and one or more corresponding proximity pilot pins. It should be appreciated that the pin configuration of first machine connector 308 and second machine connector 316 and the corresponding connections to the batteries (e.g., first battery 304 and second battery 312) and the interface controllers (e.g., first interface controller 306 and second interface controller 314) can change depending on the type of connector.

Charging system 300 can include power transfer unit 318. Charging system 300 can include housing 324, where housing 324 can house circuit 112 and controller 120. Housing 324 can be a housing configured to minimize electromagnetic interference of circuit 112 and improve thermal management of circuit 112. For example, housing 324 can include an aluminum enclosure with an integrated heatsink, an aluminum enclosure with forced ventilation, a die-cast aluminum housing, an open-frame chassis with an acrylic or polycarbonate cover, a water-cooled metal enclosure, or any other housing configured to house circuit 112 and controller 120. Housing can include one or more ports configured to receive first power port connector 320 and second power port connector 322. First power port connector 320 can connect to first power port 202 and second power port connector 322 can connect to second power port 206. In some aspects, first power port connector 320 and second power port connector 322 can include corresponding cables, where the corresponding cables connect to circuit 112. The cables can be long enough to allow charging between first battery 304 and second battery 312 when first machine 302 is separated from second machine 310. Further, first power port connector can be configured to connect to and/or interface with first machine connector 308 and second power port connector 322 can be configured to connect to and/or interface with second machine connector 316.

### INDUSTRIAL APPLICABILITY

The disclosed embodiments may be applicable to any electrical system that relies on batteries. For example, the disclosed embodiments may be applicable to or applied to heavy machinery, such as motorized construction vehicles, motorized construction equipment, drilling machines, drilling equipment, renewable energy solutions, powerplants, manufacturing systems or any other system that can rely on batteries. The disclosed embodiments may be applicable to battery-to-battery charging scenarios where the batteries included in the charging scenario have different voltages or the same voltage. In the disclosed charging system, a first battery and a second battery can charge each other bidirectionally when a first battery voltage and a second battery voltage are the same or different. For example, a controller 120 connected to a circuit 112 that includes a first DC-to-DC converter 114, a second DC-to-DC converter 116, and a DC link 118 can determine an operation mode based on a first battery voltage of a first battery 104, a second battery voltage of a second battery 108, and a power flow direction and control one or more switches corresponding to the first DC-to-DC converter 114 and the second DC-to-DC converter 116 based on the operation mode to charge the first battery 104 or the second battery 108. Circuit 112 can include a dual stage non-isolated bi-directional DC-to-DC converter topology that supports bidirectional battery-to-battery charging when first battery 104 and second battery 108 have the same or different voltages.

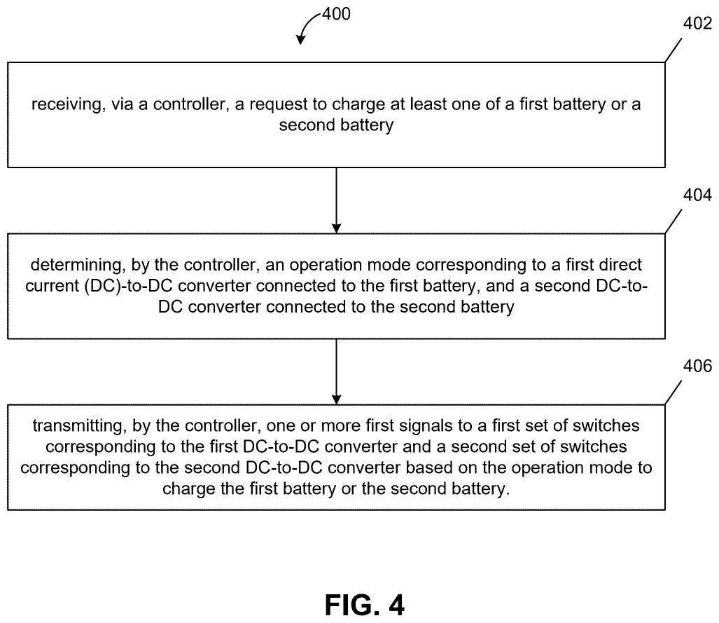

Referring now to FIG. 4, a block diagram of a method for charging batteries is provided. Method 400 can include receiving, via a controller, a request to charge at least one of a first battery and a second battery at block 402, determining, by the controller, an operation mode corresponding to a first DC-to-DC converter connected to the first battery and a DC link, and a second DC-to-DC converter connected to the second battery and the DC link at block 404, and transmitting, by the controller, one or more signals to a first set of switches corresponding to the first DC-to-DC converter and a second set of switches corresponding to the second DC-to-DC converter based on the operation mode to charge the first battery or the second battery at block 406.

At block 402, method 400 can include receiving, via a controller, a request to charge at least one of a first battery and a second battery. The request to charge at least one of the first battery and the second battery can include the power flow direction. For example, the request can designate second battery 108 as the receiver battery (e.g., the battery to be charged by the other battery), meaning the power flow direction flows from first battery 104 to second battery 108. In some aspects, a user and/or third-party can provide the request. In one example, controller 120 and/or charging system 110 can include a user interface configured to receive one or more inputs, where the one or more inputs can include the request. In another example, controller 120 can receive the request from a third-party device (e.g., mobile device, desktop computer, laptop, etc.), a console, a terminal, or any system configured to transmit the request to controller 120. As still another example, the controller 120 can receive the request from first machine 102 and the second machine 106 (e.g., via a user interface displayed on a head unit or other interface, and communicated via a control signal sent by the first machine 102 and the second machine 106 to the controller 120 (e.g., via the control pilot pin or some other communication connection between the first machine 102 and the second machine 106 and controller 120). As still another example, the controller 120 can determine the power flow direction based on a relative charge level of the batteries (e.g., where a charge level of the first battery of the first machine is greater than the charge level of the second battery of the second machine, the controller 120 can designate the second battery as the receiver battery).

At block 404, method 400 can include determining, by the controller, an operation mode corresponding to a first DC-to-DC converter connected to the first battery and a DC link, and a second DC-to-DC converter connected to the second battery and the DC link. The operation mode can correspond to a plurality of operation modes, where the plurality of operation modes can at least include a boost mode and/or a buck mode. The operation mode can be based on a first battery voltage corresponding to the first battery, a second battery voltage corresponding to the second battery, and a power flow direction indicated by the request. In one example, controller 120 can determine that the operation mode a boost mode where the power flow direction flows from first battery 104 to second battery 108—for example, first battery 104 is charging second battery 108—and the first battery voltage is less than the second battery voltage. In another example, controller 120 can determine that the operation mode is a buck mode where the power flow direction flows from second battery 108 to power battery 108—for example, second battery 108 is charging first battery 104—and the second battery voltage is greater than the first battery voltage.

At block 406, method 400 can include transmitting, by the controller, one or more signals to a first set of switches corresponding to the first DC-to-DC converter and a second set of switches corresponding to the second DC-to-DC converter based on the operation mode to charge the first battery or the second battery. The one or more signals can cause first converter 114 and second DC-to-DC converter 116 to buck and/or boost input voltages depending on the operation mode. In one example where the power flow direction flows from first battery 104 to second battery 108 and the first battery voltage is less than the second battery voltage, controller 120 can operate in the boost mode and configure first DC-to-DC converter 114 and second DC-to-DC converter to generate the desired output voltage (e.g., the second battery voltage) according to at least three different configurations. First, controller 120 can configure first DC-to-DC converter 114 to buck the input voltage (e.g., the first battery voltage) and configure second DC-to-DC converter to boost the intermediate voltage of DC link 118. Second, controller 120 can configure first DC-to-DC converter 114 to buck the input voltage (e.g., the first battery voltage) and configure second DC-to-DC converter to boost the intermediate voltage of DC link 118. Third, controller 120 can configure first DC-to-DC converter 114 to boost the input voltage (e.g., the first battery voltage) and configure second DC-to-DC converter to buck the intermediate voltage of DC link 118.

By using the systems and method described herein to charge batteries, charging system 110 can improve battery charging. First, charging system 110 can bidirectionally charge batteries with the same or different voltages according to a non-isolated bidirectional DC-to-DC converter topology without the need for an isolated bidirectional DC-to-DC converter topology, which can result in cost savings. Second, first DC-to-DC converter 114 and second DC-to-DC converter 116 do not always need to operate according to one mode (e.g., buck mode or boost mode) to generate the desired output voltage. Overall, the systems and methods described herein improve battery-to-battery charging by facilitating different battery-to-battery charging configurations.

1. A system for battery-to-battery charging, comprising:
a circuit comprising:
a first direct current (DC)-to-direct current (DC) converter configured to connect to a first battery;
a second DC-to-DC converter configured to connect to a second battery;
a DC link connecting the first DC-to-DC converter to the second DC-to-DC converter; and
a controller connected to the circuit, the controller configured to:
determine an operation mode, from a plurality of operation modes, based on a first battery voltage corresponding to the first battery, a second battery voltage corresponding to the second battery, and a power flow direction; and
control a first set of one or more switches corresponding to the first DC-to-DC converter and a second set of one or more switches corresponding to the second DC-to-DC converter based on the operation mode, to supply power from one of the first battery or the second battery, to a different one of the first battery or the second battery, according to the power flow direction.

2. The system of claim 1, wherein the plurality of operation modes comprises at least one of a buck mode and a boost mode.

3. The system of claim 2, wherein the controller is configured to:
determine the operation mode as the boost mode, responsive to a source battery voltage being less than, or less than or equal to, a receiver battery voltage;
determine the operation mode as the buck mode, responsive to the source battery voltage being greater than the receiver battery voltage,
wherein the source battery voltage comprises one of the first battery voltage or the second battery voltage, and the receiver battery voltage comprises a different one of the first battery voltage or the second battery voltage.

4. The system of claim 3, wherein the controller is configured to select the source battery voltage and the receiver battery voltage, according to the power flow direction.

5. The system of claim 1, wherein the DC link comprises one or more capacitors in parallel, the DC link configured to transfer power between the first DC-to-DC converter and the second DC-to-DC converter.

6. The system of claim 1, wherein the power flow direction is defined based on a reference current being a positive reference current or a negative reference current, the reference current flowing between the first DC-to-DC converter and the second DC-to-DC converter.

7. The system of claim 1, further comprising:
a first charging connector connected to the first DC-to-DC converter, the first charging connector configured to connect the first DC-to-DC converter to the first battery; and
a second charging connector connected to the second DC-to-DC converter, the second charging connector configured to connect the second DC-to-DC converter to the second battery.

8. The system of claim 1, further comprising:
at least one contactor connected to the DC link and the first battery or the second battery, wherein the at least one contactor is configured to receive, from the controller, one or more signals that cause the at least one contactor to create a conductive path bypassing at least one of the first DC-to-DC converter and the second DC-to-DC converter.

9. The system of claim 1, wherein the first DC-to-DC converter and the second DC-to-DC converter are buck-boost DC-to-DC converters.

10. A method of battery-to-battery charging, comprising:
receiving, via a controller, a request to charge at least one of a first battery and a second battery;
determining, by the controller, an operation mode, from a plurality of operation modes, corresponding to a first direct current (DC)-to-DC converter connected to the first battery and a DC link, and a second DC-to-DC converter connected to the second battery and the DC link, based on a first battery voltage corresponding to the first battery, a second battery voltage corresponding to the second battery, and a power flow direction indicated by the request; and
transmitting, by the controller, one or more signals to a first set of switches corresponding to the first DC-to-DC converter and a second set of switches corresponding to the second DC-to-DC converter based on the operation mode to charge the first battery or the second battery.

11. The method of claim 10, wherein the plurality of operation modes comprises at least one of a buck mode and a boost mode.

12. The method of claim 11, further comprising:
determining, by the controller, the operation mode as the boost mode, responsive to a source battery voltage being less than, or less than or equal to, a receiver battery voltage; and
determining the operation mode as the buck mode, responsive to the source battery voltage being greater than the receiver battery voltage;
wherein the source battery voltage comprises one of the first battery voltage or the second battery voltage, and the receiver battery voltage comprises a different one of the first battery voltage or the second battery voltage.

13. The method of claim 12, further comprising:
selecting, by the controller, the source battery voltage; and
receiving, by the battery voltage, according to the power flow direction.

14. The method of claim 10, further comprising:
storing electrical energy in the DC link to balance a power flow between the first DC-to-DC converter and the second DC-to-DC converter.

15. The method of claim 10, wherein the power flow direction is defined based on a reference current being a positive reference current or a negative reference current, the reference current flowing between the first DC-to-DC converter and the second DC-to-DC converter.

16. The method of claim 10, further comprising:
connecting a first charging connector to the first DC-to-DC converter, the first charging connector configured to connect the first DC-to-DC converter to the first battery; and
connecting a second charging connector to the second DC-to-DC converter, the second charging connector configured to connect the second DC-to-DC converter to the second battery.

17. The method of claim 10, further comprising:
transmitting, by the controller, one or more bypass signals to at least one contactor connected to the DC link and the first battery or the second battery to cause the one or more contactors to create a conductive path bypassing at least one of the first DC-to-DC converter and the second DC-to-DC converter.

18. The method of claim 10, wherein the first DC-to-DC converter and the second DC-to-DC converter are buck-boost DC-to-DC converters.

19. A power transfer unit, comprising:
a housing;
a circuit contained within the housing comprising:
a first direct current (DC)-to-direct current (DC) converter configured to connect to a first battery;
a second DC-to-DC converter configured to connect to a second battery;
a DC link connecting the first DC-to-DC converter to the second DC-to-DC converter; and
a controller connected to the circuit and contained within the housing, the controller configured to:
determine an operation mode, from a plurality of operation modes, based on a first battery voltage corresponding to the first battery, a second battery voltage corresponding to the second battery, and a power flow direction; and
control a first set of one or more switches corresponding to the first DC-to-DC converter and a second set of switches corresponding to the second DC-to-DC converter based on the operation mode, to supply power form one of the first battery of the second battery, to a different one of the first battery or the second battery, according to the power flow direction.

20. The power transfer unit of claim 19, wherein the plurality of operation modes comprises at least one of a buck mode and a boost mode, and wherein the controller is configured to:
determine the operation mode as the boost mode, responsive to a source battery voltage being less than, or less than or equal to, a receiver battery voltage;
determine the operation mode as the buck mode, responsive to the source battery voltage being greater than the receiver battery voltage,
wherein the source battery voltage comprises one of the first battery voltage or the second battery voltage, and the receiver battery voltage comprises a different one of the first battery voltage or the second battery voltage; and
select the source battery voltage and the receiver battery voltage, according to the power flow direction.
